(19) United States
(12) Patent Application Publication
(10) Pub. No.: US 2011/0278895 A1
(43) Pub. Date: Nov. 17, 2011

(54) ADJUSTMENT DEVICE FOR ADJUSTING A BACKREST OF A VEHICLE SEAT

(75) Inventors: Martin STEIN, Guntersblum (DE); Juergen MAIER, Weitersweiler (DE)

(73) Assignee: GM GLOBAL TECHNOLOGY OPERATIONS LLC, Detroit, MI (US)

(21) Appl. No.: 13/099,697

(22) Filed: May 3, 2011

(30) Foreign Application Priority Data
May 14, 2010 (DE) 102010020561.3

(51) Int. Cl. B60N 2/22; B60N 2/20

(52) U.S. Cl. 297/354.12

(57) ABSTRACT

An adjustment device is provided for adjusting an inclination angle of a backrest of a vehicle seat, in particular for a motor vehicle, the adjustment device being able to be actuated by a ratchet mechanism.

### CROSS-REFERENCE TO RELATED APPLICATION

This application claims priority to German Patent Application No. 102010020561.3, filed May 14, 2010, which is incorporated herein by reference in its entirety.

### TECHNICAL FIELD

The technical field generally relates to an adjustment device for adjusting an inclination angle of a backrest of a vehicle seat, in particular for a motor vehicle.

### BACKGROUND

In general, continuous and non-continuous adjustment devices are known from the prior art. The continuous adjustment devices allow an absolutely precise adjustment of the backrest. In addition, they are also lighter and more cost-effective than the non-continuous adjustment devices. However, in order to be able to operate a hand wheel for adjusting the backrest, a minimum distance must be provided between the hand wheel and a B column. Since the non-continuous adjustment devices are always adjusted using an operating lever and the actuation of the operating lever can be performed using a relatively flat hand, the distance between the operating lever and the B column can be rather small, so that the limited space available in the vehicle interior can be used better.

DE 3126142 A1 describes a continuous adjustment device for adjusting a backrest of a vehicle seat. To adjust the backrest, an operating lever is actuated, which pivots a disengagement cam, so that a locking latch is raised from a friction surface and a person can adjust the backrest using the pressure of his back or by decreasing the pressure of the back. This adjustment device locks the backrest in a friction-locked manner. In particular in the case of heavy persons, however, the backrest can adjust itself in an undesired manner due to the strong pressure of the back. Undesired adjustment of the backrest is also possible by children, for example, who kick with their feet solidly against the backrest from the backseat. Since a specific pressure is to be applied by the person when adjusting the backrest, is difficult to operate for weaker or older persons in particular.

In view of the foregoing, at least one object is to provide an adjustment device which can be adjusted without the pressure of the back. In addition, other objects, desirable features and characteristics will become apparent from the subsequent summary and detailed description, and the appended claims, taken in conjunction with the accompanying drawings and this background.

### SUMMARY

An adjustment device is provided for adjusting an inclination angle of a backrest of a vehicle seat, in particular for a motor vehicle, the adjustment device being able to be actuated by a ratchet mechanism. The ratchet mechanism can be operated using the fingers of one hand, since it only requires an extremely small application of force for actuation. This is particularly comfortable in particular for weaker or older persons. The backrest can expediently be locked in a formfitting manner in its set position, so that it reliably maintains the set position even upon the action of greater pressures or impact loads. The inclination angle of the backrest can preferably be adjusted continuously, so that a very precise adjustment is possible. However, the inclination angle of the backrest can fundamentally also be adjusted in larger or smaller steps.

To actuate the ratchet mechanism, an operating lever can be situated laterally on the vehicle seat. It may be operated not only comfortably with little use of force, but rather also allows an optimal utilization of the vehicle interior, since the distance between operating lever and the B column can be relatively small, in order to nonetheless allow comfortable actuation of the operating lever. In order that the inclination angle of the backrest can be increased and decreased using the adjustment mechanism, the action direction of the ratchet mechanism can be switched over.

In an embodiment, the ratchet mechanism can be switched over using at least one cable pull. The cable pull can be actuated easily using an operating knob or the like from the operating lever for the switch over, for example. In an alternative embodiment, the ratchet mechanism can be switched over using a rotatable handle. For this purpose, the handle can be rotatable around its longitudinal axis, so that the at least one cable pull is actuated by a slight rotation to the left or right and the action direction of the ratchet mechanism can thus be changed. The ratchet mechanism can expediently be situated on a drive rod which drives the adjustment device.

A vehicle seat, in particular for the motor vehicle, is also provided having an adjustment device in accordance with the embodiments. In addition, a motor vehicle is provided having this vehicle seat.

### BRIEF DESCRIPTION OF THE DRAWINGS

The present invention will hereinafter be described in conjunction with the following drawing figures, wherein like numerals denote like elements, and:

FIG. 1 shows a sectional view through the adjustment device;

FIG. 2 shows a perspective side view of a second embodiment of the adjustment device; and

FIG. 3 shows a perspective side view of a third embodiment of the adjustment device.

### DETAILED DESCRIPTION

The following detailed description is merely exemplary in nature and is not intended to limit application and uses. Furthermore, there is no intention to be bound by any theory presented in the preceding background or summary or the following detailed description.

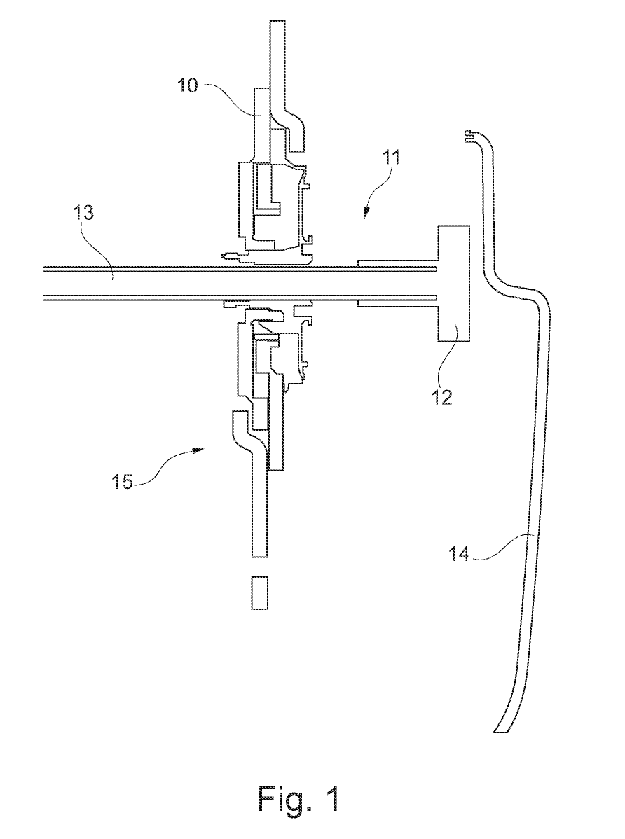

FIG. 1 shows an adjustment device 10 for the continuous adjustment of an inclination angle of a backrest (not shown in greater detail here) of a vehicle seat 15 (only indicated schematically here). The adjustment device 10 can be actuated using a ratchet mechanism 11, which is provided on a drive rod 13 in the area of an operating lever 12, and the drive rod 13. To adjust the backrest, the operating lever 12 is therefore manually operated by a person, the operating lever 12 driving the drive rod 13, and this drive rod in turn driving the adjustment device 10, via the ratchet mechanism 11. For reasons of better appearance, the operating lever 12 is partially covered using a screen 14.

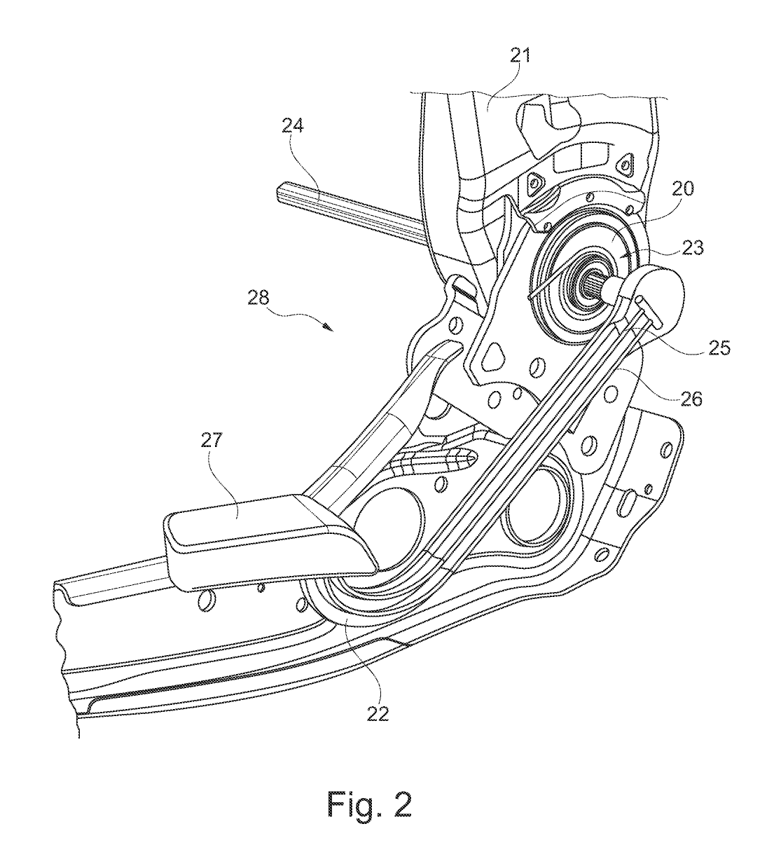

FIG. 2 shows an adjustment device 20 for the continuous adjustment of the inclination angle of a backrest 21 of a vehicle seat 28. A drive rod 24, which finally actuates the adjustment device 20, is driven using an operating lever 22 via a ratchet mechanism 23. Two cable pulls 25 and 26 are provided on the operating lever 22, in order to switch over the action direction of the ratchet mechanism 23. The switch over can be performed using an operating knob (not shown in greater detail here) or by pivoting a handle 27, for example, upward or downward or left or right, respectively.

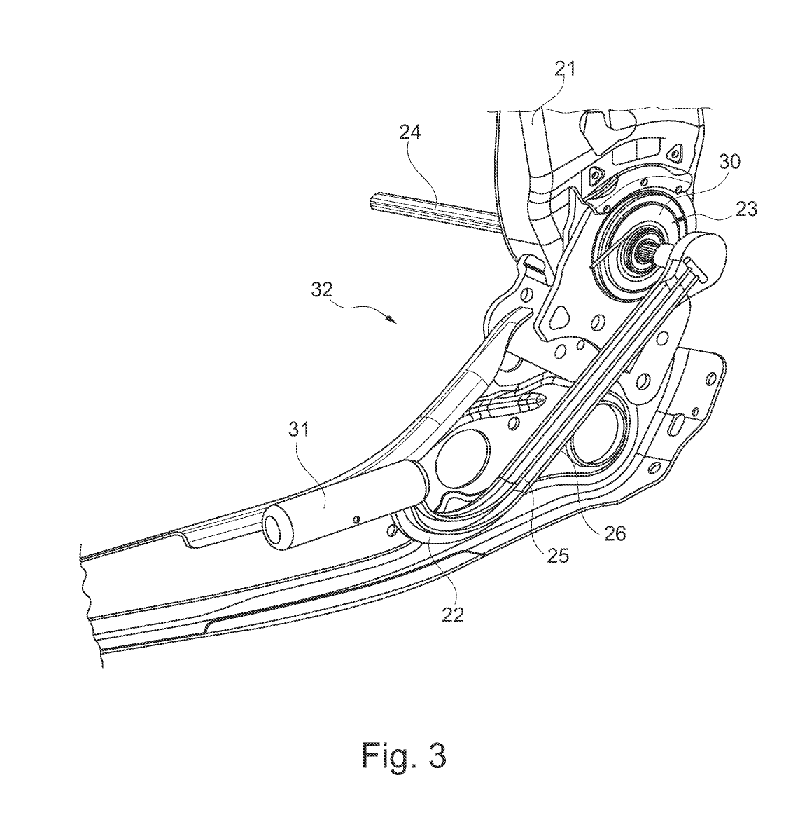

An alternative embodiment is shown in FIG. 3 having an adjustment device 30 of a vehicle seat 32. The cable pulls 25 and 26 can be actuated by a rotatable handle 31 therein. The handle 31 can be rotated around its longitudinal axis to the left or right to actuate the cable pulls 25 and 26.

Although at least one exemplary embodiment was explained in greater detail in the summary and detailed description, a large number of further embodiments must nonetheless exist. It must be emphasized that the at least one exemplary embodiment does not have the purpose of restricting the scope of protection, the field of use, or the precise design of the invention in any way. Instead, the preceding summary and detailed description are merely to give a person skilled in the art an orientation aid, in order to be able to implement at least one exemplary embodiment. Of course, many alternatives are possible with respect to the function and the configuration of the described elements, without leaving the scope of protection of the following claims.

What is claimed is:

1. An adjustment device, comprising:
a backrest of a vehicle seat with an adjustable inclination angle; and
a ratchet mechanism configured to actuate and adjust the adjustable inclination angle.

2. The adjustment device according to claim 1, wherein the adjustable inclination angle of the backrest is continuously adjustable.

3. The adjustment device according to claim 1, further comprising an operating lever situated laterally on the vehicle seat that is configured to actuate the ratchet mechanism.

4. The adjustment device according to claim 1, wherein an action direction of the ratchet mechanism is switchable.

5. The adjustment device according to claim 4, further comprising a pull cable configured to switch the action direction of the ratchet mechanism.

6. The adjustment device according to claim 4, further comprising a pivotable handle configured to switch the action direction of the ratchet mechanism.

7. The adjustment device according to claim 4, further comprising a rotatable handle configured to switch the action direction of the ratchet mechanism.

8. The adjustment device according to claim 1, further comprising a drive rod on which the ratchet mechanism is situated that is configured to drive the adjustment device.

9. A vehicle seat, comprising:
a back rest having an adjustable inclination angle; and
an adjustment device configured to adjust an inclination angle of the backrest, the adjustment device comprising a ratchet mechanism configured to actuate and adjust the adjustable inclination angle.

10. The vehicle seat according to claim 9, wherein the adjustable inclination angle of the backrest is continuously adjustable.

11. The vehicle seat according to claim 9, further comprising an operating lever situated laterally on the vehicle seat that is configured to actuate the ratchet mechanism.

12. The vehicle seat according to claim 9, wherein an action direction of the ratchet mechanism is switchable.

13. The vehicle seat according to claim 12, further comprising a pull cable configured to switch the action direction of the ratchet mechanism.

14. The vehicle seat according to claim 12, further comprising a pivotable handle configured to switch the action direction of the ratchet mechanism.

15. The vehicle seat according to claim 12, further comprising a rotatable handle configured to switch the action direction of the ratchet mechanism.

16. The vehicle seat according to claim 9, further comprising a drive rod on which the ratchet mechanism is situated that is configured to drive the adjustment device.
